(19) United States
(12) Patent Application Publication
(10) Pub. No.: US 2009/0043447 A1
(43) Pub. Date: Feb. 12, 2009

(54) Systems and Methods for Model-Based Sensor Fault Detection and Isolation

(75) Inventors: Mikhail Vershinin, Moscow (RU); Timothy Andrew Healy, Simpsonville, SC (US); Garth Curtis Frederick, Greenville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/834,955

(22) Filed: Aug. 7, 2007

(51) Int. Cl. G01M 15/00

(52) U.S. Cl. 701/34

(57) ABSTRACT

The systems and method may include receiving a plurality of measured tuning inputs associated with an operating parameter of an engine, providing a plurality of parameter estimation modules that utilize one or more component performance maps having adjustable knobs to generate model outputs, where each parameter estimation module is configured independently of a respective one of the operating parameters of the engine, and where each parameter estimation module generates the model outputs based upon fundamental inputs associated with the engine. The systems and methods may further include calculating residual values for each parameter estimation module, adjusting knobs of each parameter estimation module, and determining that a sensor associated with a measured tuning input or a fundamental input is faulty based at least in part upon values of the knobs and residual values.

### BACKGROUND OF THE INVENTION

1. Field of the Invention

Aspects of the present invention relate generally to sensor fault detection and isolation and more particularly, to model-based sensor failure detection and isolation for engines such as gas turbine engines.

2. Description of Related Art

The control and operation of current gas turbine engines depends heavily on information received from sensors. In particular, the data received from the sensors is used by control models to determine whether any control adjustments are to be made. However, when one or more sensors fail or otherwise provide inaccurate data, the control models do not operate the gas turbine engines effectively.

Current fault detection and isolation methods are effective only when the utilized system model matches the real system operation. Indeed, when the utilized model does not match with the real system operation, then sensor failure misses and false fault detections oftentimes occur. Therefore, there is a need in the industry for model-based sensor fault detection and isolation (FDI) that improves control system reliability.

### BRIEF DESCRIPTION OF THE INVENTION

A technical effect of embodiments of the present invention is the detection, isolation, and accommodation of faults in sensors used in model-based control of engines such as gas turbine engines.

Embodiments of the invention may provide for model-based sensor fault detection and isolation (FDI) that improves control system reliability. With such a model-based FDI, a faulty sensor can be detected and isolated. The faulted sensor input may then be replaced with a model estimated value, and the system models can be adjusted online to be up-to-date with the real system operation.

According to an embodiment of the invention, there is a method for providing model-based control. The method may include receiving a plurality of measured tuning inputs, where each measured tuning input is associated with an operating parameter of an engine, and providing a plurality of parameter estimation modules, where each parameter estimation module utilizes one or more component performance maps having adjustable knobs to generate model outputs, where each parameter estimation module is configured independently of a respective one of the operating parameters of the engine by receiving a surrogate knob correlated with the respective one of the operating parameters, and where each parameter estimation module generates the model outputs based upon fundamental inputs and control variables associated with the engine. The method may also include calculating residual values for each parameter estimation module by comparing the respective model outputs to a plurality of measured tuning inputs, adjusting knobs of each parameter estimation module based upon the calculated residual values, and determining that a sensor associated with a measured tuning input or a fundamental input is faulty based at least in part upon change of the knobs values and residual values for the parameter estimation modules.

According to another embodiment of the invention, there is a system for providing model-based control. The system may include one or more first sensors associated with an engine for providing a plurality of measured tuning inputs, where each measured tuning input is associated with an operating parameter of the engine, and one or more second sensors associated with the engine for providing a plurality of fundamental inputs associated with the engine. The system may also include a plurality of parameter estimation modules, where each parameter estimation module utilizes one or more component performance maps having adjustable knobs to generate model outputs, where each parameter estimation module is configured independently of a respective one of the operating parameters of the engine by receiving a surrogate knob correlated with the respective one of the operating parameters, and where each parameter estimation module generates the model outputs based upon fundamental inputs and control variables associated with the engine. The method may further include one or more arithmetic operations modules for calculating residual values for each parameter estimation module by comparing the respective model outputs to a plurality of measured tuning inputs, where knobs of each parameter estimation module are adjusted based upon the calculated residual values, and a decision module for determining that a first sensor associated with a measured tuning input or a second sensor associated with a fundamental input is faulty based upon values of the knobs and residual values for the parameter estimation modules.

According to yet another embodiment of the invention, there is a system for providing model-based control. The system may include one or more first sensors associated with an engine for providing a plurality of measured tuning inputs, where each measured tuning input is associated with an operating parameter of the engine, and one or more second sensors associated with the engine for providing a plurality of fundamental inputs associated with the engine. The system may also include a plurality of parameter estimation means, where each parameter estimation means utilizes one or more component performance maps having adjustable knobs to generate model outputs, where each parameter estimation means is configured independently of a respective one of the operating parameters of the engine by receiving a surrogate knob correlated with the respective one of the operating parameters, and where each parameter estimation means generates the model outputs based upon fundamental inputs and control variables associated with the engine. The system may further include one or more arithmetic operations modules for calculating residual values for each parameter estimation means by comparing the respective model outputs to a plurality of measured tuning inputs, where knobs of each parameter estimation means are adjusted based upon the calculated residual values, and a decision means for determining that a first sensor associated with a measured tuning input or a second sensor associated with a fundamental input is faulty based upon values of the knobs and residual values for the parameter estimation means.

### BRIEF DESCRIPTION OF THE DRAWINGS

Having thus described aspects of the invention in general terms, reference will now be made to the accompanying drawings, which are not necessarily drawn to scale, and wherein:

FIG. 1 illustrates a system for sensor failure detection and isolation, according to an embodiment of the invention.

FIG. 2 illustrates an example of adjusting knobs of the parameter estimation module, according to an embodiment of the invention.

FIGS. 3 and 4 illustrate the components and operation of a failure detection and isolation (FDI) module, according to an embodiment of the invention

FIG. 5 provides an overview of fault detection method provided by an FDI module, according to an embodiment of the invention.

FIGS. 6 and 7 provide an illustrative example for determining the stability gauges, according to an embodiment of the invention.

FIG. 8 provides an example of an operation of the threshold determination module and the decision module, according to an embodiment of the invention.

FIG. 9 provides an example of the possible stability signatures for illustrative Kalman Filters, according to an embodiment of the invention.

FIGS. 10 and 11 illustrate stability signatures for Kalman filters, given a tuning input sensor fault and a fundamental input sensor fault, according to an embodiment of the invention.

FIG. 12 provides an illustrative example of a determination of a fundamental input fault, according to an embodiment of the invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention are described below with reference to block diagrams and flowchart illustrations of systems, methods, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions, elements or steps, or combinations of special purpose hardware and computer instructions.

Embodiments of the invention may provide systems and methods for performing model-based sensor failure detection and isolation. Generally, knobs stability, as described below, and/or differences between model outputs and measured tuning inputs—that is, residuals—may be monitored to determine one or more faulty tuning input sensors or fundamental input sensors. Once a tuning input sensor or fundamental input sensor fault has been detected, the input associated with respective sensor can be detected and isolated. Other embodiments of the invention may also provide for accommodation of the detected and isolated faulty sensor.

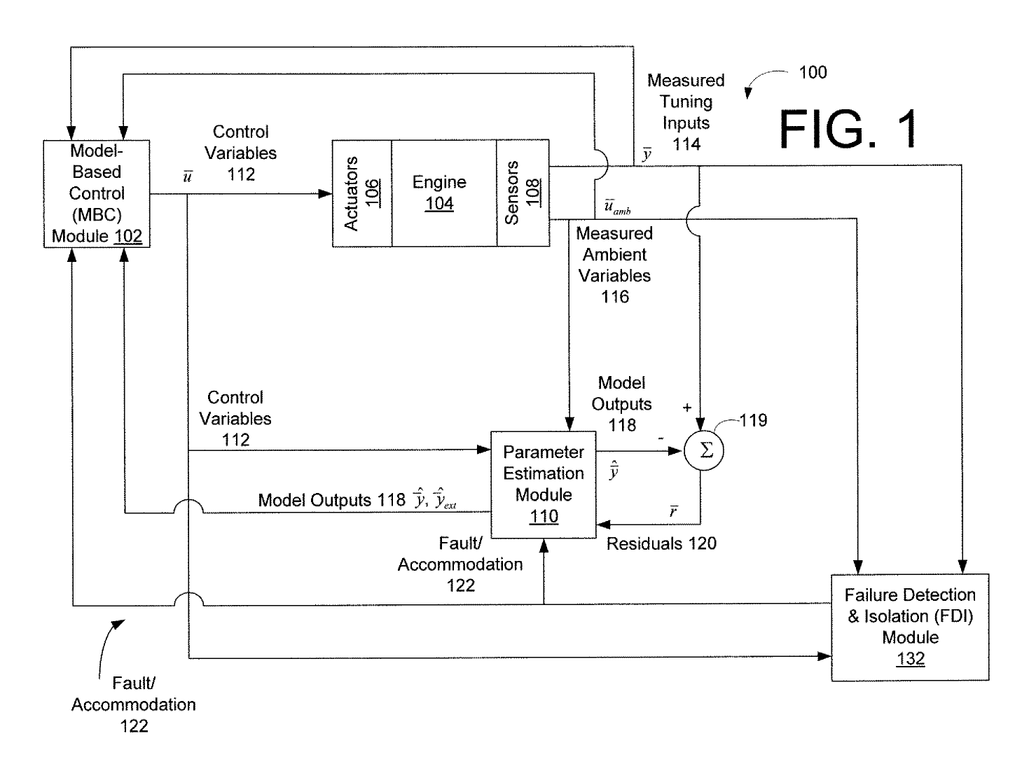

FIG. 1 illustrates an example of a system 100 that provides for model-based sensor failure detection and isolation, according to an embodiment of the invention. The system 100 may include a model-based control (MBC) module 102, an engine 104 such as a gas turbine engine, one or more actuators 106, one or more sensors 108, a parameter estimation module 110, and a Failure Detection and Isolation (FDI) module 102. Each of these components will be described in further detail below. It will be appreciated that other components beyond those described below may be included with the system 100 without departing from embodiments of the invention.

According to an embodiment of the invention, the MBC module 102 may operate the engine 104 by providing control variables 112 to the actuators 106 associated with the engine 104. As an example, these control variables 104 may include fuel flow, inlet guide vane position, and inlet bleed heat airflow. In response to receiving the control variables 112, the actuators 106 may adjust one or more positions, speeds, or other parameters of the engine 104 accordingly. During operation of the engine 104, one or more sensors 108, which include tuning input sensors and fundamental input sensors, may generate measured values for tuning inputs 114 and fundamental inputs such as ambient variables 116, respectively. Examples of the tuning inputs 114 may include a vector of one or more of the following: compressor discharge pressure (PCD), compressor discharge temperature (TCD), exhaust temperature (Tx), output power (MW), and compressor inlet temperature (CIT). Examples of fundamental inputs, which comprise ambient variables 116 and control variables 112, may include a vector of one or more of the following: ambient temperature, pressure, specific humidity, inlet pressure loss, exhaust pressure loss, manifold pressures rotation speed of shaft, inlet bleed heat airflow, fuel flow, and inlet guide vane position. While examples of tuning inputs 114 and fundamental inputs have been illustrated above, it will be appreciated that many other tuning inputs and fundamental inputs are available in accordance with other embodiments of the invention.

FIG. 1 also includes a parameter estimation module 110, which may include one or more component performance maps. The component performance maps may provide a system model for expected operational parameters of the engine 104. The component performance maps may be adjusted by updating one or more knobs, as will be described below. The parameter estimation module 110 may also be configured include or otherwise operate with one or more filters, including Kalman filters, for adjusting or updating one or more knobs. It will be appreciated that the Kalman filters may also be referred to as linear quadratic estimations (LQE), according to an embodiment of the invention. In addition, the formulations of the Kalman filters may range from the simple Kalman filters to extended filters, information filters, and variety of square-root filters developed by Bierman, Thornton, and the like.

The parameter estimation module 110 may receive control variables 112 from the MBC module 102 as well as measured ambient variables 116 from one or more sensors 108. Using the ambient variables 116, the parameter estimation module 110 may determine model outputs 118, which may be provided, perhaps in the form of a vector, to the MBC module 102. The model outputs 118 may include tuning input parameters that would be expected to be measured during operation of the engine 104, given the received control variables 112 and measured ambient variables 116.

The numbers and types of model outputs 118 may correspond to like numbers and types of measured tuning inputs 114. Thus, the model outputs 118 generated from the parameter estimation module 110 may be compared on a one-to-one basis with the measured tuning inputs 114 to generate residuals 120. Indeed, the residuals 120 may be calculated, perhaps using an arithmetic operations module 119 such as a summation or subtraction module, as a difference between the model outputs 118 and the measured tuning inputs 114, according to an embodiment of the invention. Although not illustrated in FIG. 1, the arithmetic operations module 119 may form a component of the above-described filter (e.g., Kalman filter), according to an embodiment of the invention.

The residuals 120 generated by the arithmetic operations module 119 may be in the form of a vector, especially where the model outputs 118 and measured tuning inputs 114 are likewise in the form of a vector. According to an illustrative embodiment of the invention, the residuals 120 may include, but are not limited to, one or more of PCD, TCD, Tx, and MW residuals. These residuals 120 may be received and analyzed by the parameter estimation module 110 for purposes of updating certain multipliers, or knobs, used for adjusting the component performance maps (e.g., system models) utilized for the parameter estimation module 110. Furthermore, these knobs may stored or updated, perhaps in non-volatile memory (NOVRAM). The stored knobs may be retrieved from memory to provide values for surrogate knobs for the FDI module 132 or for the MBC module 102 in the event of a tuning input sensor 108 fault.

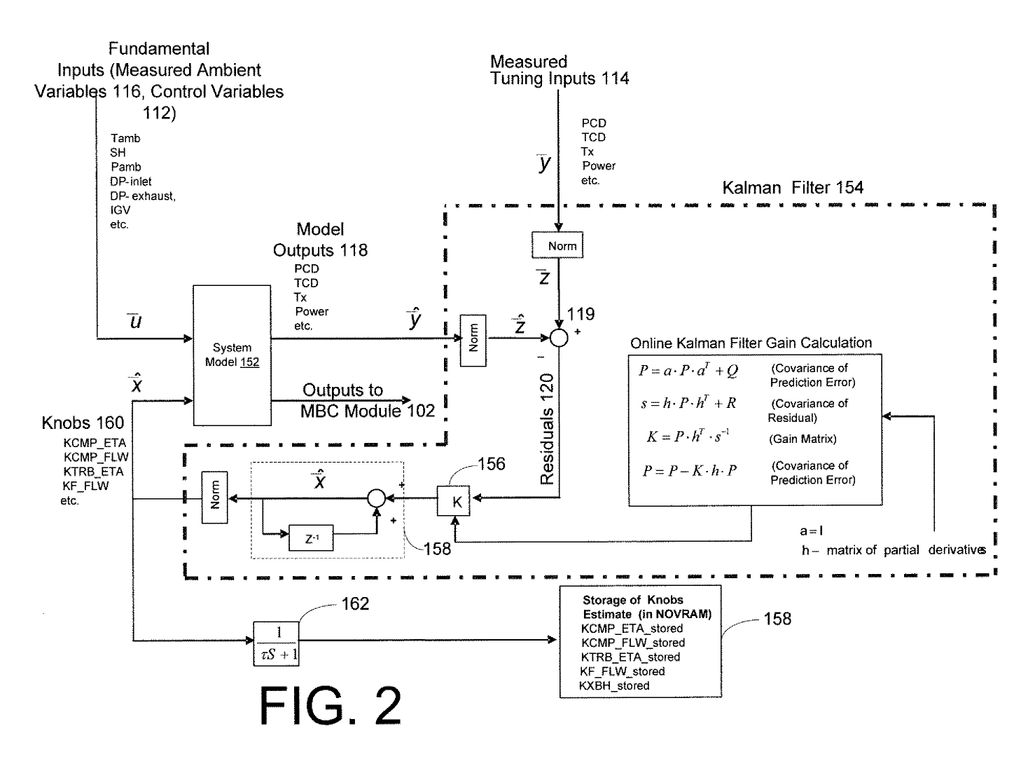

FIG. 2 illustrates an example of adjusting knobs of the parameter estimation module 110, according to an embodiment. In FIG. 2, the system model 152 may include one or more component performance maps of the parameter estimation module 110. The model outputs 118 generated by the system model 152 and the measured tuning inputs 114 may be provided to the Kalman filter 154, which may form a component of or otherwise may be associated with the parameter estimation module 110. Each of the model outputs 118 and measured tuning inputs 114 may be normalized prior to the arithmetic operations module 119 generating residuals 120. The residuals 120 are then processed by an online Kalman Filter gain calculation 156. As illustrated in FIG. 2, the online Kalman filter gain calculation 156 may be based upon certain covariance calculations. Following the online Kalman filter gain calculation 156, certain filter 154 and normalization operations may be performed to generate an estimate of the knobs 160. The knobs 160 may then be stored in memory 158 and provided to the system model 152. According to an embodiment of the invention, prior to storage, the knobs 160 may be adjusted (e.g., averaged) using a filter module 162 over a time period τ. In some embodiments, the time period τ may be a long time period (e.g., several hours) so that the knobs 160 may be adjusted slowly over a longer period of time. This slow adjustment of the knobs 160 may be helpful so that temporary fluctuations in the measured tuning inputs 114 or measured ambient variables 116 do not result in large adjustments to the knobs 160.

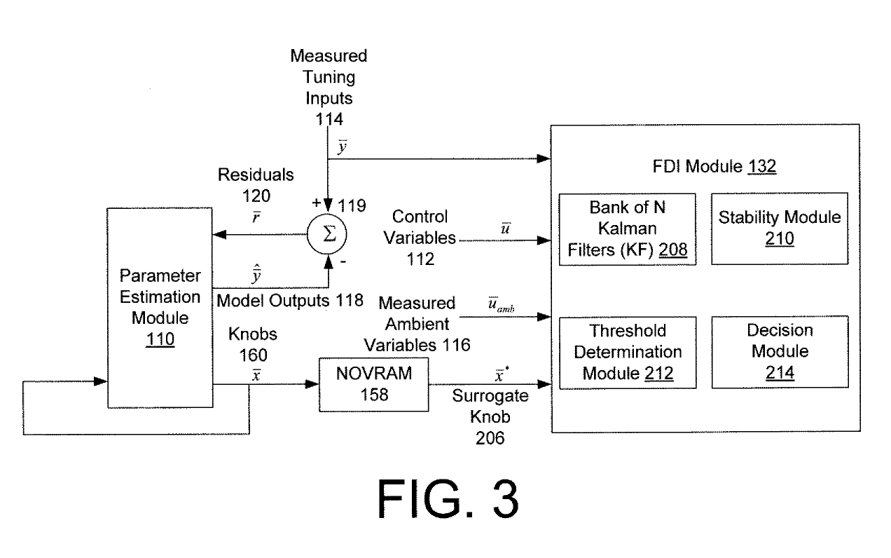

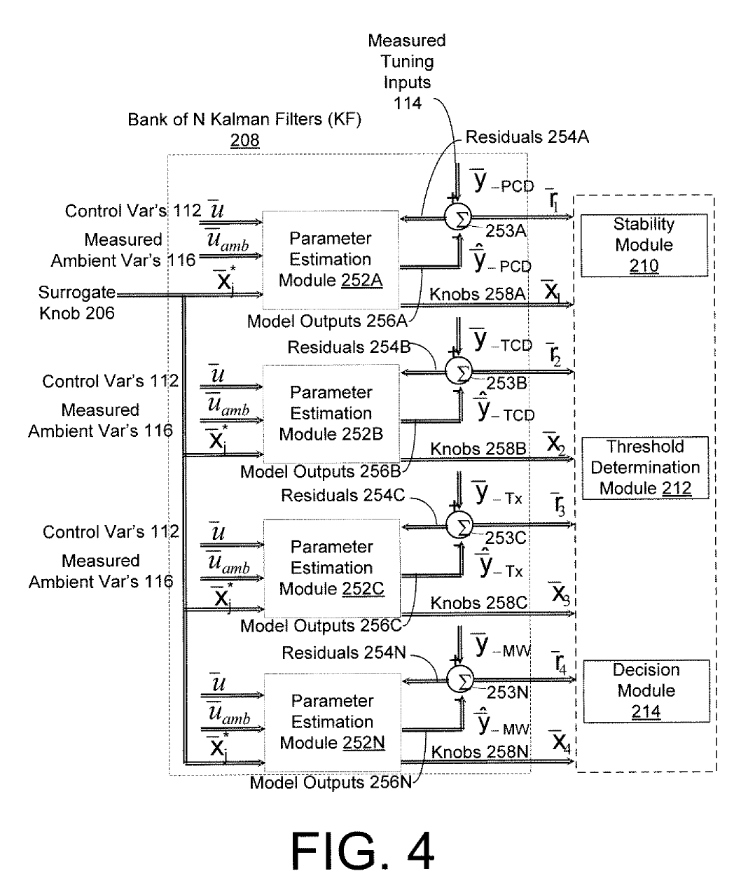

Referring back to FIG. 1, the FDI module 132 may receive control variables 112, measured tuning inputs 114, and other fundamental inputs (e.g., measured ambient variables 116). Using these received inputs, the FDI module 132 may determine whether there is a fault in one of the measured tuning input sensors and fundamental input sensors. If the FDI module 132 detects a fault in one of the sensors, it may identify and/or otherwise accommodate the fault using a fault/accommodation signal 122 to the parameter estimation module 110 and/or the MBC module 102. As will be described further in FIGS. 3 and 4, the FDI module 132 may include a bank of Kalman filters, a stability module, a threshold determination module, and a decision module that interact with each other to determine whether a tuning input sensor 108 or fundamental input sensor 108 is faulty, thus causing instability for the knobs or residuals 120.

Having generally described the system 100, the components and operation of the FDI module 132 will now be described in more detail with reference to FIGS. 3 and 4. As shown in FIG. 3, the FDI module 132 may operate concurrently with the parameter estimation module 110 described above with respect to FIGS. 1 and 2. Generally, the FDI module 132 may identify or otherwise determine faults in one or more of a tuning input or fundamental input sensor 108. During operation, the FDI module 132 may receive measured tuning inputs 114, control variables 112, and measured ambient variables 116. In addition, the FDI module 132 may also receive one or more surrogate knobs 206 retrieved from memory 158 (e.g., NOVRAM). The FDI module 132 may be comprised of a Bank of N Kalman filters 208, a stability module 210, a threshold determination module 212, and a decision module. It will be appreciated that while the modules of FDI module 132 have been illustrated separately, they may be provided as part of a single module without departing from embodiments of the invention.

The operation of the FDI module 132 will now be discussed in more detail with respect to FIG. 4. As illustrated in FIG. 4, the bank of N Kalman Filters 208 may comprise a plurality of parameter estimation modules 252A-N and a corresponding plurality of arithmetic operations modules 253A-N. The number N of parameter estimation modules 252A-N and arithmetic operations modules 253A-N may correspond to the number of variables for the measured tuning inputs 114. For example, the measured tuning inputs 114 in FIG. 4 may include the following four tuning inputs: (1) Compressor Discharge Pressure (PCD), (2) Compressor Discharge Temperature (TCD), (3) Exhaust Temperature (Tx), and (4) Output Power (MW). Accordingly, there may be four parameter estimation modules 252A-N and four arithmetic operations modules 253A-N. Each of the four parameter estimation modules 252A-N may operate independently of a single one of the variables within the measured tuning inputs 114. In particular, if there are four variables for the measured tuning inputs 114, then each one of the four parameter estimation modules 252A-N may operate with all but one (3 of 4) measured tuning inputs 114. Each parameter estimation module 252A-N may compensate for the missing tuning input 114 by receiving a surrogate knob 206 that is correlated to the missing tuning input 114.

As an example, in FIG. 4, parameter estimation module 252A may operate independently of the PCD. Accordingly, parameter estimation module 252A may receive a compressor flow KCMP_FLW surrogate knob 206, perhaps retrieved from memory 158, that is correlated with the PCD. Parameter estimation module 252A may also receive control variables 112 and measured ambient variables 116 and generate model outputs 256A. Model outputs 256A may then be compared to the measured tuning inputs 114, and residuals 254A may be generated. The residuals 254A besides the PCD residual may be used by parameter estimation module 252A to determine whether to adjust any knobs 258A. Both the residuals 254A and the knobs 258A may be provided to the stability module 210, the threshold determination module 212, and the decision module 214 for further processing.

Likewise, parameter estimation module 252B may operate independently of the TCD, and parameter estimation module 252B may receive a compressor efficiency KCMP_ETA surrogate knob 206 that is correlated with the TCD. Parameter estimation module 252B may also receive control variables 112 and measured ambient variables 116 and generate model outputs 256B. Model outputs 256B may then be compared to the measured tuning inputs 114, and residuals 254B may be generated. The residuals 254B besides the TCD residual may be used by parameter estimation module 252B to determine whether to adjust any knobs 258B. Both the residuals 254B and the knobs 258B may be provided to the stability module 210, the threshold determination module 212, and the decision module 214 for further processing.

Similarly, parameter estimation module 252C may operate independently of the Tx, and parameter estimation module 252C may receives a fuel flow knob KF_FLW surrogate knob 206 that is correlated with the Tx. Parameter estimation module 252C may also receive control variables 112 and measured ambient variables 116 and generate model outputs 256C. Model outputs 256C may then compared to the measured tuning inputs 114 and residuals 254C are generated. The residuals 254C besides the Tx residual may be used by parameter estimation module 252C to determine whether to adjust any knobs 258C. Both the residuals 254C and the knobs 258C may be provided to the stability module 210, the threshold determination module 212, and the decision module 214 for further processing.

Finally, parameter estimation module 252N may operate independently of the MW, and parameter estimation module 252D may receive a turbine efficiency KTRB_ETA surrogate knob 206 that is correlated with the MW. Parameter estimation module 252N also receives control variables 112 and measured ambient variables 116 and generates model outputs 256N. Model outputs 256N are then compared to the measured tuning inputs 114, and residuals 254N are generated. The residuals 254N besides the MW residual are used by parameter estimation module 252N to determine whether to adjust any knobs 258N. Both the residuals 254N and the knobs 258N are available to the stability module 210, the threshold determination module 212, and the decision module 214 for further processing.

Generally, the stability module 210 may be utilized by FDI module 132 to calculate one or more gauges of stability for the knobs 206 and/or specific residuals 254A-N like PCD residual of 254A, TCD residual of 254B, Tx residual of 254C, MW residual of 254N. The threshold determination module 212 may determine whether these stability gauges exceed one or more thresholds (e.g., coarse thresholds, fine thresholds), which may be predetermined thresholds. As will be described in further detail below, if one or more thresholds have been exceeded, then the decision module 214 may determine a tuning input sensor 108 fault or a fundamental input sensor 108 fault.

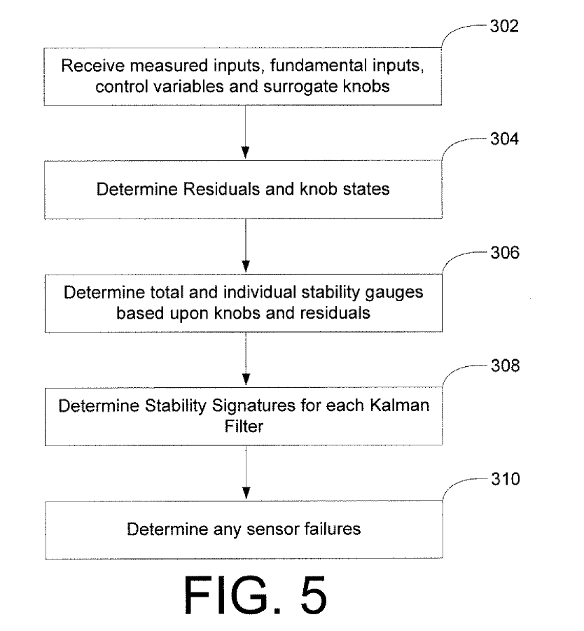

FIG. 5 provides an overview of fault detection method provided by an FDI module 132. In step 302, the FDI module 132 may receive inputs such as measured tuning inputs, fundamental inputs and surrogate knobs, as described above. In step 304, the Bank of N Kalman filters 208 may process the received inputs to generate residuals and knob states. In step 306, the residuals and knob states may be processed by the stability module 210 to determine a total knobs stability gauge and a total residuals stability gauge for the entire Bank of N Kalman filters 208. In addition, the stability module 210 may determine a particular stability gauge and a particular residuals stability gauge for each Kalman filter within the Bank of N Kalman filters 208. In step 308, the threshold determination module 212 may analyze the total and individual stability gauges to determine stability signatures for each Kalman filter within the Bank of N Kalman filters 208. These stability signatures may then be provided to the decision module 214 for a determination of any sensor faults, as provided by step 310.

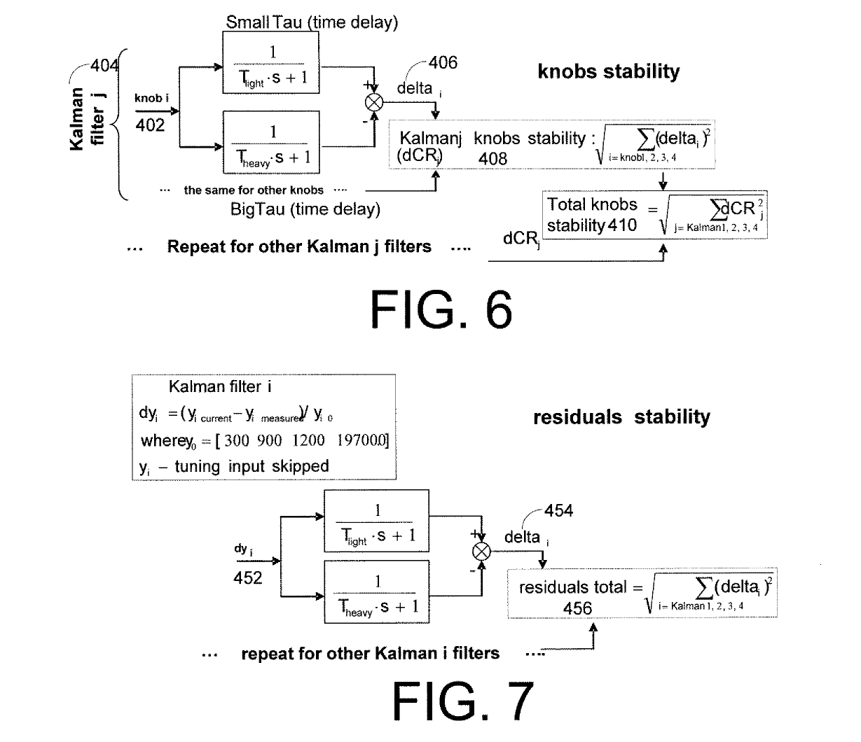

FIGS. 6 and 7 provide an illustrative example for determining the stability gauges described in step 306 of FIG. 5. In particular, FIG. 6 illustrates an example of a process for determining a knobs stability gauges, according to an embodiment of the invention. As shown in FIG. 6, each knob i 402 associated with a respective Kalman filter j 404 may be processed using a small time constant T_{light} (e.g., for a short time period such as 1-30 seconds) lag filter and a larger time constant T_{heavy} (e.g., for a longer time period such as 90-2,000 seconds) lag filter. After each knob i 402 has been processed by a small time constant T_{light} lag filter and a larger time constant T_{heavy} lag filter, the resulting signals may be subtracted to generate a delta; signal 406. The deltaᵢ signal 406 for each knob i may then be processed by the following algorithm to generate the respective Kalman filter j knobs stability gauge (dCRⱼ) 408:

$$\sqrt{{\sum }_{i = knob 1 , 2 , 3 , 4} {( {delta}_{i} )}^{2}} ,$$

assuming that there are four knobs i per Kalman filter j. Once the knobs stability gauges (dCRⱼ) 408 have been determined for each Kalman filter j, the total knobs stability gauge 410 may be determined by the following algorithm:

$$\sqrt{{\sum }_{j = Kalman 1 , 2 , 3 , 4} {( {dcR}_{j} )}^{2}} ,$$

assuming that there are only 4 Kalman filters j. It will be appreciated by those of ordinary skill in the art that the above-described algorithms may be extended to systems having various numbers of Kalman filters and various numbers of knobs per Kalman filter without departing from embodiments of the invention.

FIG. 7 illustrates an example of a process for determining residuals stability gauges, according to an embodiment of the invention. In FIG. 7, the residual dyᵢ 452 for each Kalman filter i may be processed using a small time constant T_{light} lag filter and a larger time constant T_{heavy} lag filter. After each residual dyᵢ 452 has been processed by a small time constant T_{light} lag filter and a larger time constant T_{heavy} lag filter, the resulting signals are subtracted to generate a deltaᵢ signal 454. The residuals total stability gauge 456 may be determined by the

$$\sqrt{{\sum }_{i = Kalman 1 , 2 , 3 , 4} {( {delta}_{i} )}^{2}} ,$$

following algorithm: assuming that there are only 4 Kalman filters i. It will be appreciated that the above-described algorithm may be extended to systems having various numbers of Kalman filters i without departing from embodiments of the invention.

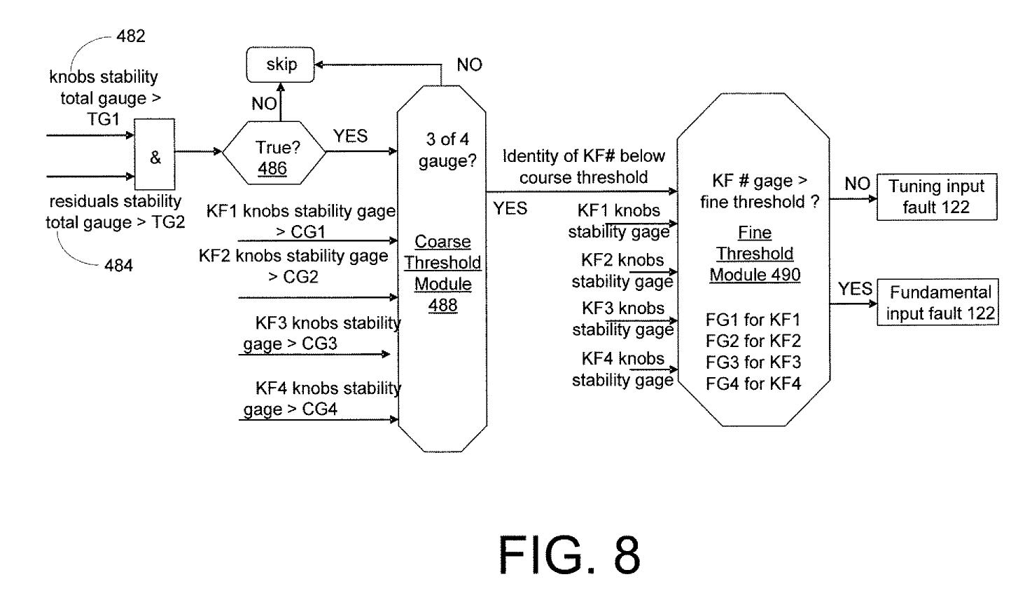

Turning now to FIG. 8, there is provided an example of an operation of the threshold determination module 212 and the decision module 214 of steps 308 and 310 of FIG. 5, according to an embodiment of the invention. Although steps 308 and 310 and other steps of FIG. 5 have been illustrated separately, they may be combined into a single step without departing from embodiments of the invention. Further, the example of FIG. 8 assumes that there are four Kalman filters in the Bank of N Kalman filters 208 for detecting sensor faults associated with one of the four variables for measured tuning inputs (e.g., PCD, TCD, Tx, and MW). However, it will be appreciated that the numbers of Kalman filters may be adjusted according to the number variables within the measured tuning inputs, according to an embodiment of the invention.

Still referring to FIG. 8, if the knobs stability total gauge 482 exceeds a first threshold TG1 and the residuals stability total gauge 484 exceeds second threshold TG2 in block 486, then there may be a potential tuning input or fundamental input sensor fault. Processing then proceeds with the coarse threshold module 488, which may be a component of threshold determination module 212, determining whether 3 of the 4 respective Kalman Filter (KF) knobs stability gauges exceeds their respective coarse thresholds CG1-4. If not, then no fault is detected by the decision module 214. If so, then processing proceeds the fine threshold module 490 examining the identified Kalman filter knob stability gauge that did not exceed its respective coarse threshold CG1-4. In particular, fine threshold module 490 may determine whether the identified Kalman filter knob stability gauge exceeds a respective fine threshold FG1-FG4. If the particular Kalman Filter knobs stability gauge does not exceed its respective fine threshold FG1-FG4, then the stability signatures provide that three of the four Kalman Filters exceeded their respective threshold(s) while a single Kalman Filter did not exceed its threshold(s). Based upon the stability signature, the decision module 214 may determine a tuning input fault 122.

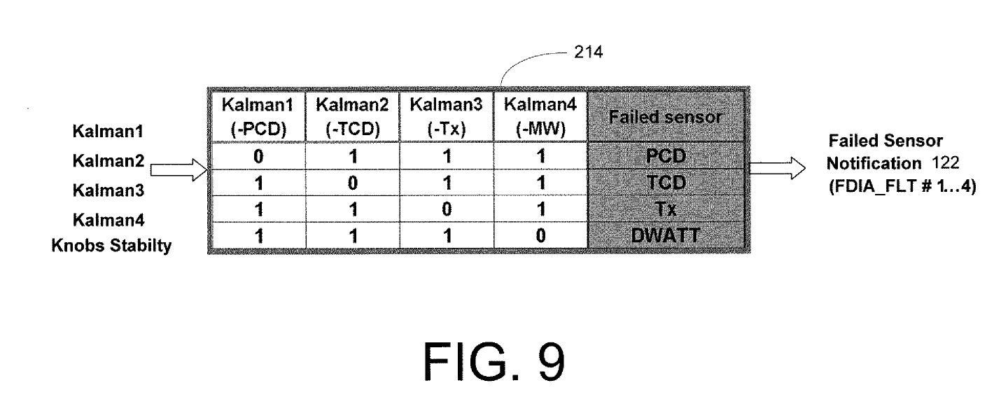

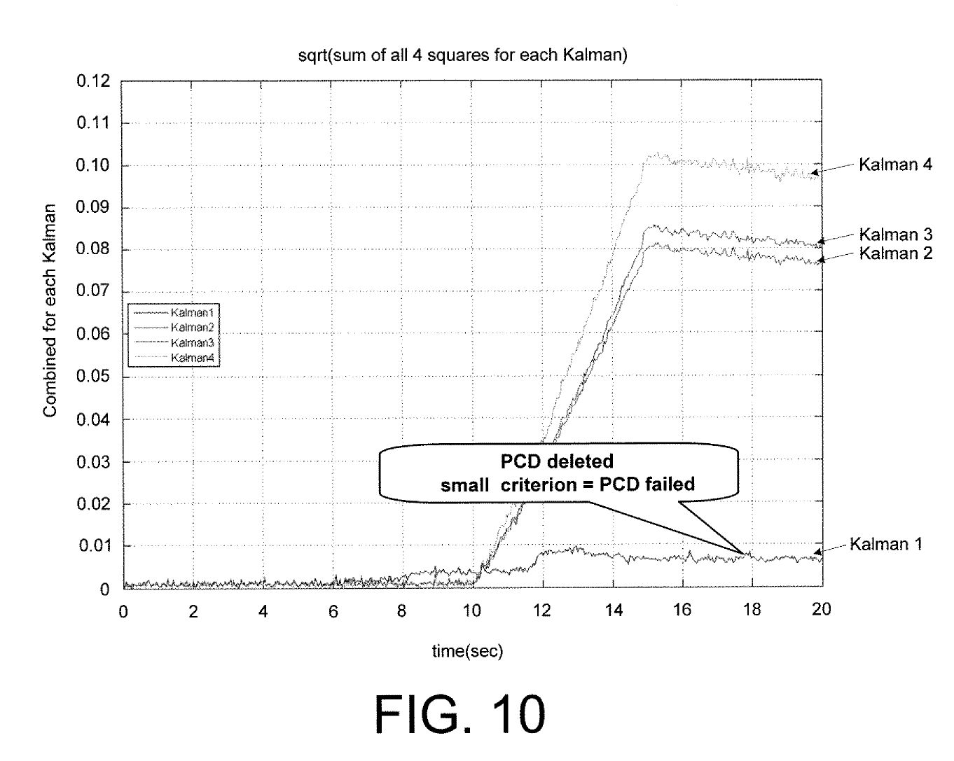

As a more illustrative example, FIG. 9 provides an example of the possible stability signatures for each of the four Kalman Filters. In FIG. 9, the Kalman1 filter may operate independently of the PCD; the Kalman2 filter may operate independently of the TCD; the Kalman3 filter may operate independently of Tx; and the Kalman4 filter of MW, according to an embodiment of the invention. Accordingly, referring, for example, to the first row of FIG. 6, if the Kalman1 filter does not exceed its respective threshold(s) while all of the Kalman2-4 filters exceed their respective threshold(s), then such stability signatures may indicate that the PCD sensor is faulty. FIG. 10 provides a graphical illustration of such a failure of the PCD sensor, which results in three of the four Kalman Filters exceeding their respective threshold(s) while a single Kalman Filter did not exceed its threshold(s).

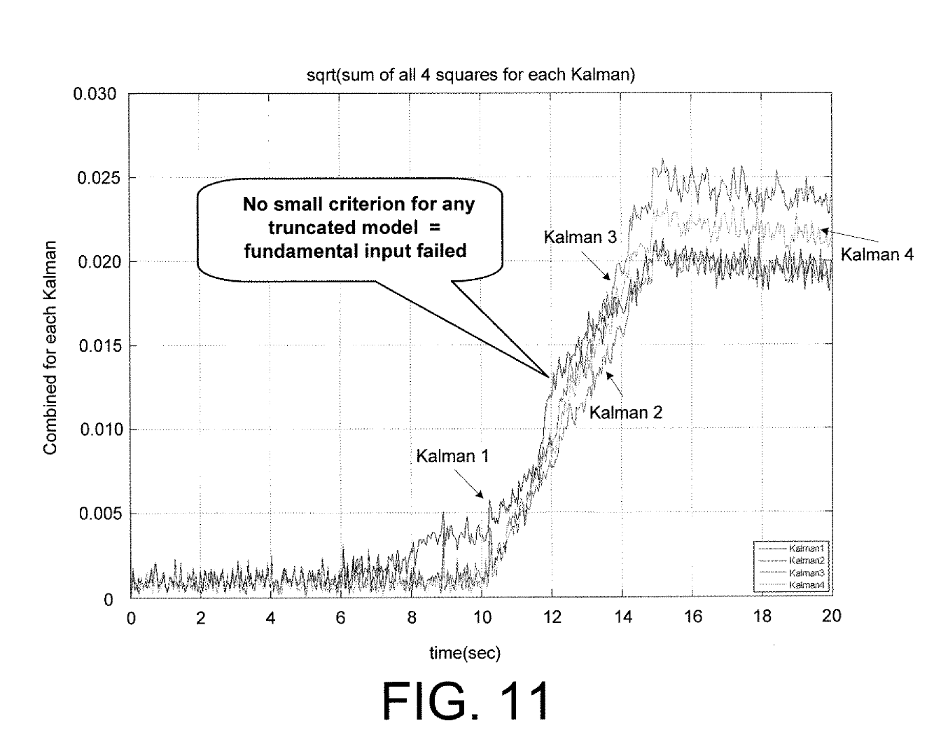

Referring back to FIG. 8, fine threshold module 320 may alternatively determine that the identified Kalman filter knob stability gauge does not exceed its respective fine threshold FG1-FG4. An example of this situation is provided by the graphical illustration of FIG. 11. In this case, the stability signatures provide that all four Kalman Filters exceeded their respective threshold(s) and no particular tuning input fault may be identified. Instead, the decision module 214 may identify a fundamental input sensor fault by calculating relative stability gauges and comparing probabilities of certain fundamental input faults based upon the values of the relative stability gauges at the moment of failure detection and predefined probability density functions inherent for each fundamental input fault. The decision module 214 may identify the fundamental input fault by accepting a hypothesized fundamental input fault with maximum probability. The decision module 214 may determine a fundamental input fault 122.

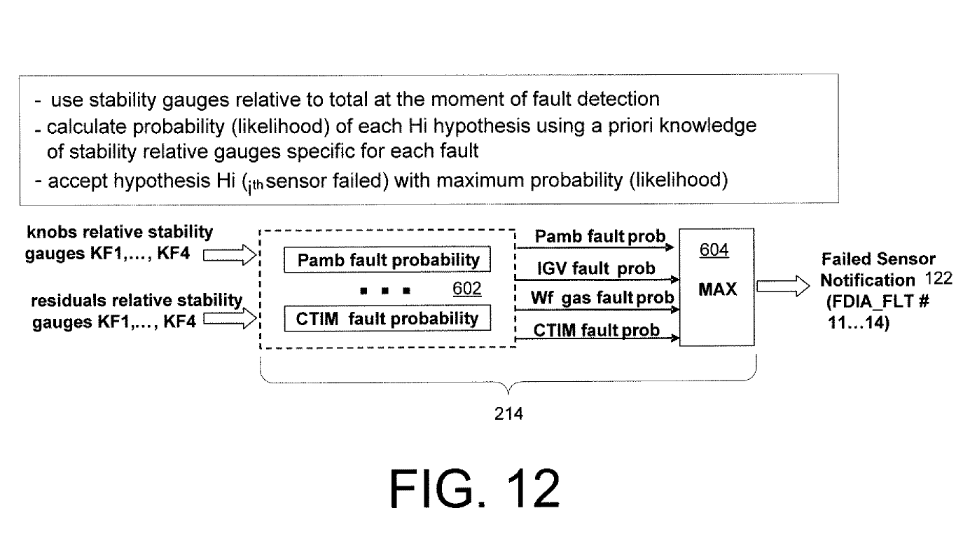

FIG. 12 provides an illustrative example of a method by which decision module 214 determines a fundamental input fault 122. As illustrated in FIG. 12, decision module 214 comprises a probability module 602 and a selection module 604. The probability module 602 may receive knobs relative stability gauges and residuals relative stability gauges determined by the stability module 210. While fault detected knobs relative stability gauges are calculated at this moment by means of individual knobs stability gauges division by knobs total stability gauge. Likewise residuals relative stability gauges are calculated at the moment of fault detection by means of individual residuals stability gauges division by residuals total stability gauge. The probability module 602 may then calculate, using relative stability gauges, the probabilities for each Hi hypothesis (ith fundamental input sensor failure such as Pamb fault, CTIM fault, etc.). Each hypothesis is described by probabilistic Gauss distribution in space of relative stability gauges with simulation predefined means and standard deviations. Provision of these Gauss distributions with relative stability gauges gives a probability of each hypothesis. These probabilities are then provided to the selection module 604, which accepts the hypothesis Hi of the ith sensor failure with maximum likelihood.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for providing model-based control, comprising:
receiving a plurality of measured tuning inputs, wherein each measured tuning input is associated with an operating parameter of an engine;
providing a plurality of parameter estimation modules, wherein each parameter estimation module utilizes one or more component performance maps having adjustable knobs to generate model outputs, wherein each parameter estimation module is configured independently of a respective one of the operating parameters of the engine by receiving a surrogate knob correlated with the respective one of the operating parameters, and wherein each parameter estimation module generates the model outputs based upon fundamental inputs associated with the engine;
calculating residual values for each parameter estimation module by comparing the respective model outputs to a plurality of measured tuning inputs;
adjusting knobs of each parameter estimation module based upon the calculated residual values; and
determining that a sensor associated with a measured tuning input or a fundamental input is faulty based at least in part upon values of the knobs and residual values for the parameter estimation modules.

2. The method of claim 1, wherein the component performance maps are associated with a simulated operation of the engine, and wherein the knobs are multipliers for adjusting parameters of the component performance maps.

3. The method of claim 1, wherein the measured tuning inputs include two or more of the following: (i) compressor discharge pressure (PCD), (ii) compressor discharge temperature (TCD), (iii) exhaust temperature (Tx), (iv) output power (MW), and (v) compressor inlet temperature (CIT), and wherein the fundamental inputs include two or more of the following: (i) ambient temperature, (ii) pressure, (iii) specific humidity, (iv) inlet pressure loss, (v) exhaust pressure loss, (vi) manifold pressure, (vii) rotation speed of shaft, (viii) inlet bleed heat airflow, (ix) fuel flow, and (x) inlet guide vane position.

4. The method of claim 1, wherein determining that a sensor associated with a measured tuning input or a fundamental input is faulty includes determining a knobs stability gauge for each of the plurality of parameter estimation modules based upon the respective knobs and determining a residuals stability gauge for each of the plurality of parameter estimation modules based upon the respective residual values.

5. The method of claim 4, wherein a sensor associated with a measured tuning input is determined to be faulty based at least in part on all but one of the knobs stability gauges exceeding a threshold.

6. The method of claim 4, wherein determining that a sensor is faulty includes determining that the sensor is faulty based at least in part on all of the knobs stability gauges exceeding a threshold.

7. The method of claim 6, wherein determining that a sensor is faulty includes determining that the sensor is faulty based upon a determination of one or more probabilities of (i) a particular knobs stability gauge relative to a total knobs stability gauge, and (ii) a particular residuals stability gauge relative to a total residuals stability gauge.

8. The method of claim 4, wherein each knobs stability gauge is determined for each of the plurality of parameter estimation modules by comparing the respective knobs over a short time period and a long time period, and wherein each residuals stability gauge is determined for each of the plurality of parameter estimation modules by comparing the respective residual values over the short time period and the long time period.

9. The method of claim 1, wherein the engine is a gas-turbine engine and wherein the plurality of parameter estimation modules form a bank of Kalman filters.

10. A system for providing model-based control, comprising:
one or more first sensors associated with an engine for providing a plurality of measured tuning inputs, wherein each measured tuning input is associated with an operating parameter of the engine;
one or more second sensors associated with the engine for providing a plurality of fundamental inputs associated with the engine;
a plurality of parameter estimation modules, wherein each parameter estimation module utilizes one or more component performance maps having adjustable knobs to generate model outputs, wherein each parameter estimation module is configured independently of a respective one of the operating parameters of the engine by receiving a surrogate knob correlated with the respective one of the operating parameters, and wherein each parameter estimation module generates the model outputs based upon fundamental inputs associated with the engine;
one or more arithmetic operations modules for calculating residual values for each parameter estimation module by comparing the respective model outputs to a plurality of measured tuning inputs, wherein knobs of each parameter estimation module are adjusted based upon the calculated residual values; and
a decision module for determining that a first sensor associated with a measured tuning input or a second sensor associated with a fundamental input is faulty based upon values of the knobs and residual values for the parameter estimation modules.

11. The system of claim 10, wherein the component performance maps are associated with a simulated operation of the engine, and wherein the knobs are multipliers for adjusting parameters of the component performance maps.

12. The system of claim 10, wherein the measured tuning inputs include two or more of the following: (i) compressor discharge pressure (PCD), (ii) compressor discharge temperature (TCD), (iii) exhaust temperature (Tx), (iv) output power (MW), and (v) compressor inlet temperature (CIT), and wherein the fundamental inputs include two or more of the following: (i) ambient temperature, (ii) pressure, (iii) specific humidity, (iv) inlet pressure loss, (v) exhaust pressure loss, (vi) manifold pressure, (vii) rotation speed of shaft, (viii) inlet bleed heat airflow, (ix) fuel flow, and (x) inlet guide vane position.

13. The system of claim 10, further comprising a stability module for determining a knobs stability gauge for each of the plurality of parameter estimation modules based upon the respective knobs and for determining a residuals stability gauge for each of the plurality of parameter estimation modules based upon the respective residual values, wherein the knobs stability gauges and residuals stability gauges are provided to the decision module for determining that a first sensor associated with a measured tuning input or a second sensor associated with a fundamental input is faulty.

14. The system of claim 13, further comprising a threshold module for determining whether any knobs stability gauges exceed a threshold, wherein the decision module determines that a first sensor associated with a measured tuning input is faulty based at least in part on all but one of the knobs stability gauges exceeding a threshold.

15. The system of claim 13, further comprising a threshold module for determining whether any knobs stability gauges exceed a threshold, wherein the decision module determines that a second sensor associated with a fundamental input is faulty based at least in part on all of the knobs stability gauges exceeding a threshold.

16. The system of claim 15, wherein a second sensor associated with a fundamental input is determined to be faulty by the decision module based upon one or more probabilities of (i) a particular knobs stability gauge relative to a total knobs stability gauge, and (ii) a particular residuals stability gauge relative to a total residuals stability gauge.

17. The system of claim 13, wherein each knobs stability gauge is determined by the stability module for each of the plurality of parameter estimation modules by comparing the respective knobs over a short time period and a long time period, and wherein each residuals stability gauge is determined by the stability module for each of the plurality of parameter estimation modules by comparing the respective residual values over the short time period and the long time period.

18. The system of claim 10, wherein the engine is a gas-turbine engine and wherein the plurality of parameter estimation modules form a bank of Kalman filters.

19. A system for providing model-based control, comprising:
one or more first sensors associated with an engine for providing a plurality of measured tuning inputs, wherein each measured tuning input is associated with an operating parameter of the engine;
one or more second sensors associated with the engine for providing a plurality of fundamental inputs associated with the engine;
a plurality of parameter estimation means, wherein each parameter estimation means utilizes one or more component performance maps having adjustable knobs to generate model outputs, wherein each parameter estimation means is configured independently of a respective one of the operating parameters of the engine by receiving a surrogate knob correlated with the respective one of the operating parameters, and wherein each parameter estimation means generates the model outputs based upon fundamental inputs associated with the engine;
one or more arithmetic operations modules for calculating residual values for each parameter estimation means by comparing the respective model outputs to a plurality of measured tuning inputs, wherein knobs of each parameter estimation means are adjusted based upon the calculated residual values; and
a decision means for determining that a first sensor associated with a measured tuning input or a second sensor associated with a fundamental input is faulty based upon values of the knobs and residual values for the parameter estimation means.

20. The system of claim 19, wherein the measured tuning inputs include two or more of the following: (i) compressor discharge pressure (PCD), (ii) compressor discharge temperature (TCD), (iii) exhaust temperature (Tx), (iv) output power (MW), and (v) compressor inlet temperature (CIT), and wherein the fundamental inputs include two or more of the following: (i) ambient temperature, (ii) pressure, (iii) specific humidity, (iv) inlet pressure loss, (v) exhaust pressure loss, (vi) manifold pressure, (vii) rotation speed of shaft, (viii) inlet bleed heat airflow, (ix) fuel flow, and (x) inlet guide vane position.
